(19) United States
(12) Patent Application Publication
(10) Pub. No.: US 2017/0329847 A1
(43) Pub. Date: Nov. 16, 2017

(54) GRAPHICAL IDENTIFIER SCANNING METHOD AND DEVICE

(71) Applicant: Alibaba Group Holding Limited, Grand Cayman (KY)

(72) Inventor: Kaimin QUI, Hangzhou (CN)

(21) Appl. No.: 15/535,038

(22) PCT Filed: Dec. 18, 2015
(86) PCT No.: PCT/CN2015/096726

§ 371 Date: Jun. 10, 2017

(30) Foreign Application Priority Data
Dec. 15, 2014 (CN) 201410778107.9

(51) Int. Cl. G06F 17/30; G06K 7/00

(52) U.S. Cl. CPC G06F 17/30725; G06K 7/00

(57) ABSTRACT

The disclosure provides a graphical identifier scanning method and device. The method includes: receiving an information acquisition request sent by a client, the information acquisition request including an identity of a graphical identifier; acquiring an information list corresponding to the identity of the graphical identifier, the information list storing mapping relationships between at least two pieces of information and different parameter values based of a preset parameter type; acquiring a current parameter value when receiving the information acquisition request, and determining current information corresponding to the current parameter value using the information list; and sending the current information to the client. The method and the device disclosed in the disclosure can rapidly achieve the purpose of using a graphical identifier set at a fixed location to indicate different information.

### CROSS-REFERENCE TO RELATED APPLICATIONS

This application claims the benefit of priority of Chinese Patent Application No. 201410778107.9, filed on Dec. 15, 2014 and PCT Application No. PCT/CN2015/096726, filed on Dec. 8, 2015, which are incorporated herein in their entirety by reference.

### BACKGROUND

### Technical Field

The disclosed embodiments relate to the field of data processing, and in particular, to a graphical identifier (e.g., barcode) scanning method and device.

### Description of the Related Art

A barcode refers to a graphical identifier having a rule-based arrangement and used for representing a set of information. At present, graphical identifiers may include one-dimensional barcodes, two-dimensional barcodes, three-dimensional barcodes, color barcodes, and so on, and more types of graphical identifiers may emerge with the continuous development of information technology.

A barcode is usually used for indicating some fixed information. For example, a barcode is used to indicate information such as a commodity name, a book classification number, or a mailing date. With the application of barcodes in the fields such as commodity marketing, it is hoped that a barcode set at a fixed location can be used to indicate different information. The fixed location for setting the barcode may be a designated location on a poster, a designated location on a webpage, or the like.

In the case that the fixed location is a designated location on a poster, the purpose of using the barcode set at the fixed location to indicate different information can be achieved by manually updating information indicated by the barcode without replacing the poster.

In the case that the fixed location is a designated location on a webpage, the purpose of using the barcode set at the fixed location to indicate different information can be achieved by manually updating the barcode or manually updating information indicated by the barcode.

Problems such as low update efficiency and inflexible updating exist when the aforementioned manual update methods are employed to achieve the purpose of using the barcode set at the fixed location to indicate different information.

### BRIEF SUMMARY

The technical problem to be solved by the disclosed embodiments is to provide a barcode scanning method for rapidly achieving the purpose of using a barcode set at a fixed location to indicate different information.

The disclosure further provides a barcode scanning device for ensuring the implementation and application of the aforementioned method in practice.

In order to solve the aforementioned problems, the embodiments disclosed herein are directed to a barcode scanning method, which includes the following steps: receiving an information acquisition request sent by a client, the information acquisition request including an identity of a barcode; acquiring an information list corresponding to the identity of the barcode, the information list storing mapping relationships between at least two pieces of information and different parameter values of a preset parameter type; acquiring a current parameter value when the client sends the information acquisition request, and determining current information corresponding to the current parameter value using the information list; and sending the current information to the client.

The embodiments disclosed herein are further directed to a barcode scanning device, which includes: a receiving module, configured to receive an information acquisition request sent by a client, the information acquisition request including an identity of a barcode; an acquisition module, configured to acquire an information list corresponding to the identity of the barcode, the information list storing mapping relationships between at least two pieces of information and different parameter values of a preset parameter type; a determining module, configured to acquire a current parameter value when the client sends the information acquisition request, and determine current information corresponding to the current parameter value using the information list; and a sending module, configured to send the current information to the client.

The embodiments disclosed herein are further directed to an apparatus that integrates the foregoing device in a processor thereof.

As compared with current techniques, the disclosed embodiments have the following advantages: after an information acquisition request sent by a client is received, an information list corresponding to a scanned barcode can be acquired according to an identity of the barcode included in the request, and then a current parameter value when the client sends the information acquisition request is used to find current information corresponding to the current parameter value from the information list, and the current information is fed back to the client. In this way, the purpose of using a barcode set at a fixed location to indicate different information can be rapidly achieved without manually updating the barcode and/or information indicated by the barcode.

### BRIEF DESCRIPTION OF THE DRAWINGS

In order to illustrate the technical solution in the embodiments more clearly, the drawings required for describing the embodiments will be introduced briefly below. The drawings described below are merely some disclosed embodiments, and those of ordinary skill in the art can also obtain other drawings according to these drawings without significant effort.

FIG. 1 is a flow diagram of a method of barcode scanning according to some embodiments of the disclosure.

FIG. 2 is a flow diagram of a method of barcode scanning according to some embodiments of the disclosure.

FIG. 3 is a block diagram of a barcode scanning device according to some embodiments of the disclosure.

### DETAILED DESCRIPTION

The disclosed embodiments are described clearly and completely below with reference to the drawings. The described embodiments are merely some, rather than all of the contemplated embodiments. On the basis of the embodiments, all other embodiments obtained by those of ordinary skill in the art without making creative efforts shall fall within the protection scope of the disclosure.

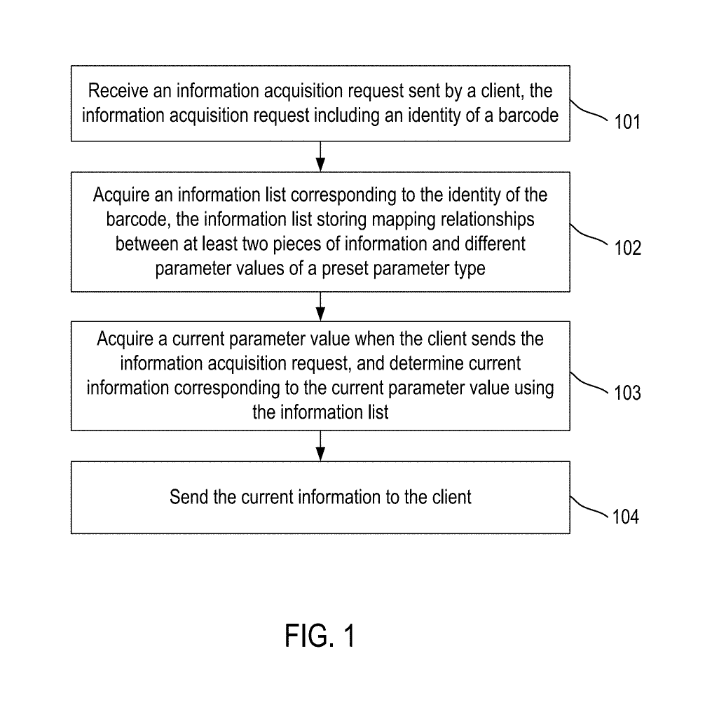

FIG. 1 is a flow diagram of a method of barcode scanning method according to some embodiments of the disclosure. The method may be specifically applied to a barcode scanning device integrated in a processor of an electronic apparatus. This embodiment may include the following steps.

Step 101: Receive an information acquisition request sent by a client, the information acquisition request including an identity of a barcode.

In one embodiment, the client comprises a barcode scanner or an intelligent terminal having a barcode scanning function. After a user scans a barcode with the client, an information acquisition request may be sent to a barcode scanning device, and then information indicated by the scanned barcode is acquired.

For example, an electronic apparatus integrated with the barcode scanning device may be a client, or may be other apparatuses capable of communicating with the client.

In some embodiments, the identity of the barcode comprises a barcode serial number and/or information indicated by the barcode. Using information comprising a network address as an example, the identity of the barcode may be a network address of a proxy server, or may be one of at least two network addresses stored in an information list. Information lists are described in more detail below, the disclosure of which is not repeated in detail herein but is incorporated by reference in its entirety.

Step 102: Acquire an information list corresponding to the identity of the barcode, the information list storing mapping relationships between at least two pieces of information and different parameter values of a preset parameter type.

In one embodiment, an information list capable of storing at least two mapping relationships may be set based on a preset parameter type. The purpose of using a barcode at a fixed location to indicate at least two pieces of information can be achieved based on at least two mapping relationships in the information list. The information list may be one list or multiple lists; or, the information list may be an application capable of calculating a mapping relationship between information and a parameter value, which may not be specifically defined in this embodiment, as long as the information list corresponding to the scanned barcode can be obtained correctly through the identity of the barcode.

For example, a preset parameter type may be at least one of a time parameter, a location parameter, a numerical parameter, user information, and client information. The location parameter may be geographical location information and/or an IP address. The user information may be at least one of identity information of the user, visitor information allocated by a website to the user, and information such as user preference. The numerical parameter may be a random number or a serial number. The client information may be apparatus identity information and/or intrinsic information of an apparatus. The intrinsic information of the apparatus may be an operating system type, a system version number, or an device model identifier and so on.

For example, if the preset parameter type is a time parameter, the mapping relationship may be a corresponding relationship between information and a time segment. If the preset parameter type is a location parameter, the mapping relationship may be a corresponding relationship between information and a geographical location, or a corresponding relationship between information and an IP network segment. If the preset parameter type is a numerical parameter, the mapping relationship may be a corresponding relationship between information and a random number, or a corresponding relationship between information and a serial number. If the preset parameter type is user information, the mapping relationship may be a corresponding relationship between information and user preference, and so on. The specific representation of the mapping relationship may not be specifically defined in this embodiment.

The information list in this embodiment is illustrated below with reference to specific examples.

Some commodities may have different names in different regions. Accordingly, mapping relationships between commodity names and geographical locations may be established and stored in the information list. In this way, when users in different regions scan a barcode at the same location, the users can obtain commodity names corresponding to the geographical locations of the users.

Some webpages may display different content for different regions. Accordingly, mapping relationships between webpage content and geographical locations may be established and stored in the information list. In this way, when users in different regions scan a barcode at the same location, the users can obtain webpage content corresponding to the geographical locations of the users.

It should be understood that a geographical location of a user may be a default geographical location preset by the user, or may be a geographical location determined according to a network segment where a client held by the user is located.

Some webpages may display different content in different time segments. Accordingly, mapping relationships between webpage content and time segments may be established and stored in the information list. In this way, when a user scans a barcode at the same location in different time segments, the user can obtain webpage content corresponding to the current time segment.

Some webpages may display different content for different regions in different time segments. Accordingly, mapping relationships between webpage content, geographical locations, and time segments may be established and stored in the information list. In this way, corresponding webpage content can be obtained based on two parameters, that is, a geographical location and a time segment.

Some webpages may display different content to different users. Accordingly, mapping relationships between webpage content and user information may be established and stored in the information list. In this way, when different users scan a barcode at the same location, the users can obtain webpage content corresponding to user information.

Some webpages may display different content to different clients. Accordingly, mapping relationships between webpage content and client information may be established and stored in the information list. In this way, when a user scans a barcode at the same location with different clients, the user can obtain webpage content corresponding to the client used by the user.

In addition, as discussed above, mapping relationships between information and numerical parameters may also be utilized. For example, if the information list stores mapping relationships between information and random numbers, a display proportion of each piece of information may also be set according to actual demands. For example, the display proportion is set according to a hotspot of each piece of information, the display proportion is set according to the processing capacity of a website corresponding to each piece of information, or the like, which may not be specifically defined in the embodiments of the disclosure. For example, an information list corresponding to one barcode stores three pieces of information A, B, and C, the display proportion of each piece of information is 10%, 20%, and 70%, respectively, and random numbers 1-10, 11-30, and 31-100 may be allocated to the information A, B, and C, respectively, according to the proportions, so as to establish mapping relationships between information and random numbers. In this way, when a user scans a barcode at the same location, a random number can be generated for the user and information corresponding to the random number is obtained.

It should be understood that display of different content may be displayed from the same network address, or may be displayed through different network addresses.

Using a mapping relationships between network addresses and time segments as an example, referring to Table 1, the information list in one embodiment may be:

TABLE 1

| Parameter value | Information |
|---|---|
| Time segment A | Network address A |
| Time segment B | Network address B |
| Time segment C | Network address C |
| Time segment D | Network address B |
| . . . | . . . |

It should be understood that the information list may be stored locally in the barcode scanning device, and upon receiving the information acquisition request, the barcode scanning device directly reads the information list locally. Alternatively, or in conjunction with the foregoing, the information list may be stored in other apparatuses, and upon receiving the information acquisition request, the barcode scanning device reads the information list from said other apparatuses.

Step 103: Acquire a current parameter value when the client sends the information acquisition request, and determine current information corresponding to the current parameter value using the information list.

As discussed above, the information list associated with one barcode at a fixed location may indicate at least two pieces of information. In order to select information currently indicated by the barcode from the at least two pieces of information, a current parameter value may be acquired, and then current information corresponding to the current parameter value is searched for in the information list. Alternatively, if the information list is an application capable of calculating a mapping relationship between information and a parameter value, the barcode scanning device may invoke an application corresponding to the identity of the barcode and the application performs calculation to obtain current information corresponding to the current parameter value.

In some embodiments, the current parameter value may be a parameter value used the client sends the information acquisition request, that is, a parameter value when the client scans the barcode.

Referring to the example given in Table 1, the current parameter value may be a time T when the client sends the information acquisition request, and the barcode scanning device may determine a time segment to which the time T belongs and determine a network address corresponding to the network segment. For example, if the time segment to which the time T belongs is the time segment A, the barcode scanning device determines that the current information corresponding to the current parameter value is the network address A.

Alternatively, the current parameter value may be a random number generated by the barcode scanning device for the client when the client sends the information acquisition request. For example, if the generated random number is 50 (with reference to the example given previously) the random number 50 belongs to the range of 31-100, and then the barcode scanning device determines that the current information corresponding to the current parameter value is the information C. In this way, proportional traffic distribution can be realized, which helps guide network access of a user, alleviates the access load of a website, and improves access processing efficiency of the web site.

Alternatively, the current parameter value may be a number randomly allocated by the barcode scanning device to the client when the client sends the information acquisition request. For example, an information list corresponding to one barcode stores three pieces of information A, B, and C, the number of each piece of information is 1, 2, and 3, respectively, and if a number randomly allocated by the barcode scanning device to a user A upon sending an information acquisition request at a first time is 1, it can be determined that the current information corresponding to the current parameter value is the information A. If a number randomly allocated by the barcode scanning device to the user A when the user A sends an information acquisition request at a second time is 3, it can be determined that the current information corresponding to the current parameter value is the information C. In this way, random traffic distribution can be realized, and each time a user scans a barcode at the same location, the user can obtain different information, which helps improve user experience.

Alternatively, the current parameter value may be user information and/or client information obtained by the barcode scanning device when the client sends the information acquisition request. For example, an information list corresponding to one barcode stores two pieces of information A and B, where the information A corresponds to an ANDROID® operating system, and the information B corresponds to an IOS® operating system. If the client sending the information acquisition request is the IOS® operating system, it can be determined that the current information corresponding to the current parameter is the information B. In this way, personalized traffic distribution can be realized, so that information can be provided to users in a more targeted manner.

In addition to the traffic distribution modes introduced above, polled traffic distribution, odd-even traffic distribution, and so on may also be realized based on the mapping relationships in the embodiments of the disclosure, and is not illustrated in detail herein.

It should be noted that the barcode scanning device may acquire the current parameter value while determining the current information as shown in FIG. 1. Alternatively, the barcode scanning device may acquire the current parameter value upon receiving the information acquisition request. In another alternative, the barcode scanning device may acquire the current parameter value upon acquiring the information list, which may not be specifically defined in this embodiment, as long as the current parameter value is acquired before the current information is determined.

Step 104: Send the current information to the client.

Once the current information corresponding to the current parameter value is determined in step 103, the barcode scanning device can feed back the current information to the client, so that the client displays the result of scanning the barcode to the user, that is, the client is used to display the current information.

For example, if the current information is a commodity name, upon receiving the current information sent by the barcode scanning device, the client may display to the user the commodity name currently indicated by the scanned barcode.

As an alternative example, if the current information is a network address, upon receiving the current information sent by the barcode scanning device, the client may display to the user the webpage content at the network address currently indicated by the scanned barcode.

As an alternative example, if the current information is a network address, the barcode scanning device may send the current information to the client in the following two ways.

In a first embodiment, the barcode scanning device sends the current information to the client. With reference to the example given above, the barcode scanning device sends the network address A to the client, so that the client displays webpage content at the network address A to the user.

In a second embodiment, the barcode scanning device sends a network address of a proxy server to the client. With reference to the example given above, the barcode scanning device sends a network address of a proxy server to the client, so that the client can access the network address of the proxy server, and then be redirected to the network address A via the proxy server, so as to achieve the purpose of displaying webpage content at the network address A to the user. In this manner, the client can only obtain the network address of the proxy server, which can guarantee the security of the current network address.

In view of the above, according to the steps shown in FIG. 1, when it is required to acquire current information indicated by a barcode, the barcode scanning device can use a current parameter value when the client sends an information acquisition request to determine current information corresponding to the current parameter value from the information list. In this way, the purpose of using a barcode set at a fixed location to indicate different information can be rapidly achieved without manually updating the barcode and/or information indicated by the barcode.

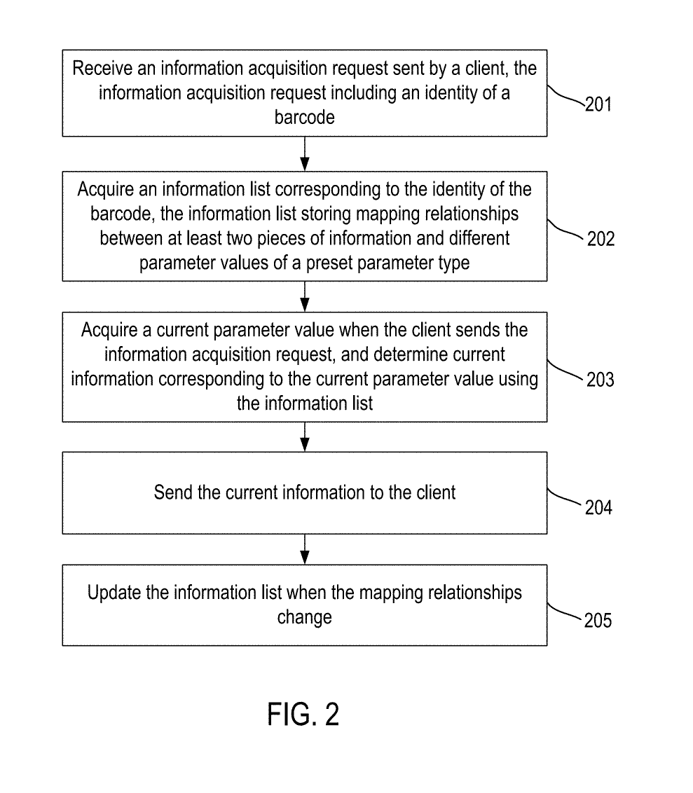

FIG. 2 is a flow diagram of a method of barcode scanning according to some embodiments of the disclosure. The method may be specifically applied to a barcode scanning device integrated in a processor of an electronic apparatus. This embodiment may include the following steps.

Step 201: Receive an information acquisition request sent by a client, the information acquisition request including an identity of a barcode.

Step 202: Acquire an information list corresponding to the identity of the barcode, the information list storing mapping relationships between at least two pieces of information and different parameter values of a preset parameter type.

Step 203: Acquire a current parameter value when the client sends the information acquisition request, and determine current information corresponding to the current parameter value using the information list.

Step 204: Send the current information to the client.

Reference may be made to steps 101-104 in the embodiment shown in FIG. 1 for a description of steps 201-204, which will not be described here again and is incorporated herein by reference in its entirety.

Step 205: Update the information list when the mapping relationships change.

In one embodiment, an information list update mechanism is further provided to improve the flexibility of the barcode scanning method in the disclosed embodiments. In some embodiments, a change of the mapping relationships comprises the addition or deletion of a mapping relationship in the information list, or comprises a change of the information and/or parameter values in the mapping relationships.

Referring to the example given in Table 1, the mapping relationship between the time segment D and the network address B may change, and, in response, the network address B is updated to the network address D. After such an update, the information list stores a mapping relationship between the time segment D and the network address D.

Referring to the example given in Table 1, the mapping relationship between the time segment D and the network address B may change again, wherein the time segment D is subdivided into time segments D1 and D2. In this example, the time segment D1 corresponds to the network address B and the time segment D2 corresponds to the network address D. After such an update, the information list no longer stores the mapping relationship between the time segment D and the network address B, but stores a mapping relationship between the time segment D1 and the network address B and a mapping relationship between the time segment D2 and the network address D.

In view of the above, according to the steps shown in FIG. 2, the barcode scanning device only needs to update relevant data in the information list when the mapping relationships change, so that the update process is simple and convenient and highly efficient and flexible.

In order to describe the foregoing embodiments briefly, all the embodiments are expressed as a serial combination of actions, but those skilled in the art should know that the disclosed embodiments should not be limited by the specific, ordered sequence of the described actions as certain steps may be performed in parallel. Secondly, those skilled in the art should also know that the embodiments described in the specification are exemplary embodiments, and the related actions and modules are not necessarily required for the these embodiments.

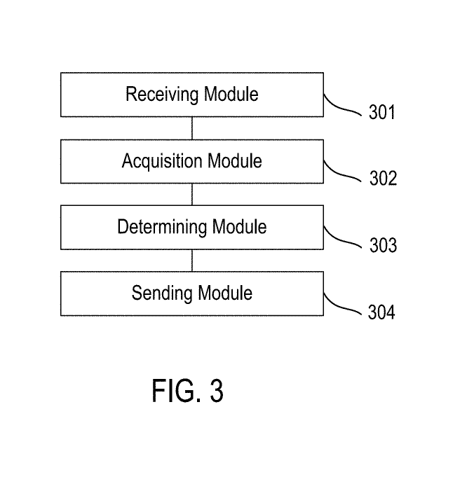

Corresponding to the embodiments described in connection with FIG. 1, FIG. 3, is a block diagram of a barcode scanning device according to some embodiments of the disclosure. In this embodiment, the device may include: a receiving module 301, an acquisition module 302, a determining module 303, and a sending module 304.

In the illustrated embodiment, the receiving module 301 receives an information acquisition request sent by a client, the information acquisition request including an identity of a barcode.

The identity of the barcode may be a number of the barcode and/or information indicated by the barcode. Using information being a network address as an example, in this embodiment, the identity of the barcode may be a network address of a proxy server, or may be one of at least two network addresses stored in an information list.

In the illustrated embodiment, the acquisition module 302 acquires an information list corresponding to the identity of the barcode, the information list storing mapping relationships between at least two pieces of information and different parameter values of a preset parameter type.

Reference may be made to the embodiments of methods for processing the preset parameter and the mapping relationships, which will not be described here again.

In the illustrated embodiment, the determining module 303 acquires a current parameter value when the client sends the information acquisition request, and determines current information corresponding to the current parameter value using the information list.

In the illustrated embodiment, the sending module 304 sends the current information to the client.

Corresponding to the foregoing method embodiments, if the current information is a current network address, the sending module may send the current information to the client in the following two ways.

In a first embodiment, the sending module sends the current information to the client, so that the client displays webpage content at the current network address to a user.

In a second embodiment, the sending module sends a network address of a proxy server to the client, and performs a redirection to the current network address via the proxy server, so as to display webpage content at the current network address to the user.

As described above, when required to acquire current information indicated by a barcode, the barcode scanning device can use a current parameter value when the client sends an information acquisition request to determine current information corresponding to the current parameter value from the information list. In this manner, the purpose of using a barcode set at a fixed location to indicate different information can be rapidly achieved without manually updating the barcode and/or information indicated by the barcode.

In other embodiments, the barcode scanning device may further include an update module that updates the information list when the mapping relationships change.

According to some embodiments, an information list update mechanism is further provided to improve the flexibility of the barcode scanning device. It should be understood that a change of the mapping relationships may be the addition or deletion of a mapping relationship in the information list, or may be a change of the information and/or parameter values in the mapping relationships.

The disclosure further provides an electronic apparatus, which integrates the foregoing barcode scanning device in a processor thereof.

It should be noted that each embodiment in the disclosure is described in a progressive manner, with each embodiment focusing on parts different from other embodiments, and reference can be made to each other for identical and similar parts among various embodiments. With regard to the device embodiments, since the device embodiments are substantially similar to the method embodiments, the description is relatively simple, and reference can be made to the description of the method embodiments for related parts.

Finally, it should also be noted that relational terms such as first and second are used herein only to distinguish one entity or operation from another entity or operation without necessarily requiring or implying that there are these actual relations or orders between the entities or operations. Furthermore, the terms “comprising,” “including,” or any other variation thereof are intended to encompass a non-exclusive inclusion so that a process, method, article, or apparatus that includes a series of elements includes not only those elements but also other elements not explicitly listed, or elements that are inherent to such a process, method, article, or apparatus. The element defined by the statement “comprising one . . . ”, without further limitation, does not preclude the presence of additional identical elements in the process, method, article, or apparatus that includes the element.

Hereinbefore, a barcode scanning method and device provided in the disclosure are introduced in detail, the principles and implementations of the embodiments are set forth herein with reference to specific examples, descriptions of the above embodiments are merely served to assist in understanding the method and essential ideas of the disclosure. To those of ordinary skill in the art, changes may be made to specific implementation manners and application scopes according to the ideas of the disclosure; in view of the above, the disclosure should not be construed as limiting the disclosure.

1-10. (canceled)

11. A method comprising:
receiving an information acquisition request from a client device, the information acquisition request including an identity of a graphical identifier and a current parameter value;
retrieving an information list associated with the identity of the graphical identifier, the information list storing a mapping of information to a plurality of parameter values;
extracting current information from the information list based on the current parameter value; and
transmitting the current information to the client device.

12. The method of claim 11 wherein the plurality of parameter values are of a type selected from one of a time, location, numerical, user information, and client information type.

13. The method of claim 11 wherein the mapping of information to the plurality of parameter values comprises a mapping selected from the group consisting of:
a mapping of commodity names to geographic locations;
a mapping of webpage content to geographic locations;
a mapping of webpage content to time segments;
a mapping of webpage content to users;
a mapping of webpage content to client devices; and
a mapping of network addresses to time segments.

14. The method of claim 11 wherein the mapping of information to the plurality of parameter values comprises a mapping of information to numerical parameters.

15. The method of claim 14 wherein the numerical parameters comprise random numbers.

16. The method of claim 11 wherein the current parameter value is generated by the client device by an application invoked based on the identity of the graphical identifier.

17. The method of claim 11 wherein mapping of information to the plurality of parameter values comprises a mapping of information to operating system values and wherein the current parameter value comprises a value representing an operating system installed on the client device.

18. The method of claim 11 wherein the identity of a graphical identifier comprises a network address of a proxy server or a network address stored within the information list and wherein the information list stores a mapping of network addresses to a plurality of parameter values.

19. The method of claim 16 wherein the current information comprises a current network address associated with the current parameter value and wherein transmitting the current information to the client device comprises:
sending the network address of a proxy server to the client device; and
redirecting a request of the client device to the current network address via the proxy server.

20. The method of claim 11 further comprising updating the information list when the mapping of information to the plurality of parameter values changes.

21. An apparatus comprising:
one or more processors; and
a non-transitory memory storing computer-executable instructions therein that, when executed by the processors, cause the apparatus to perform the operations of:
receiving an information acquisition request from a client device, the information acquisition request including an identity of a graphical identifier and a current parameter value;
retrieving an information list associated with the identity of the graphical identifier, the information list storing a mapping of information to the plurality of parameter values;
extracting current information from the information list based on the current parameter value; and
transmitting the current information to the client device.

22. The apparatus of claim 21 wherein the plurality of parameter values are of a type selected from one of a time, location, numerical, user information, and client information type.

23. The apparatus of claim 21 wherein the mapping of information to the plurality of parameter values comprises a mapping selected from the group consisting of:
a mapping of commodity names to geographic locations;
a mapping of webpage content to geographic locations;
a mapping of webpage content to time segments;
a mapping of webpage content to users;
a mapping of webpage content to client devices; and
a mapping of network addresses to time segments.

24. The apparatus of claim 21 wherein the mapping of information to the plurality of parameter values comprises a mapping of information to numerical parameters.

25. The apparatus of claim 24 wherein the numerical parameters comprise random numbers.

26. The apparatus of claim 21 wherein the current parameter value is generated by the client device by an application invoked based on the identity of the graphical identifier.

27. The apparatus of claim 21 wherein mapping of information to the plurality of parameter values comprises a mapping of information to operating system values and wherein the current parameter value comprises a value representing an operating system installed on the client device.

28. The apparatus of claim 21 wherein the identity of a graphical identifier comprises a network address of a proxy server or a network address stored within the information list and wherein the information list stores a mapping of network addresses to a plurality of parameter values.

29. The apparatus of claim 26 wherein the current information comprises a current network address associated with the current parameter value and wherein transmitting the current information to the client device comprises:
sending the network address of a proxy server to the client device; and
redirecting a request of the client device to the current network address via the proxy server.

30. The apparatus of claim 21 wherein the instructions further cause the apparatus to perform the operation of updating the information list when the mapping of information to the plurality of parameter values changes.
